(19) United States
(12) Patent Application Publication
(10) Pub. No.: US 2026/0116450 A1
(43) Pub. Date: Apr. 30, 2026

(54) PORTABLE AND FRAMELESS FOLDING CART CAPABLE OF BEING FOLDED WITHOUT INCREASING HEIGHT

(71) Applicant: Zhejiang Pride Leisure Products Co,. Ltd., Jinhua (CN)

(72) Inventor: Benlong SUN, Jinhua (CN)

(21) Appl. No.: 19/375,187

(22) Filed: Oct. 30, 2025

(30) Foreign Application Priority Data
Oct. 30, 2024 (CN) 202411533227.2

(51) Int. Cl. B62B 3/02; B62B 5/06; B62B 5/04

(52) U.S. Cl. CPC B62B 3/022; B62B 5/061; B62B 5/065; B62B 5/0433

(57) ABSTRACT

A portable and frameless folding cart capable of being folded without increasing the height; the cart includes: four vertical bars divided into front vertical bars and rear vertical bars; bottom sleeves mounted at bottom ends of the vertical bars; a first cross bar and a second cross bar which are mounted between the bottom sleeves; first retaining rings mounted at the bottom ends of the front vertical bars and second retaining rings mounted at the bottom ends of the rear vertical bars; first upright bars arranged rotatably and second upright bars arranged rotatably; hinge sleeves mounted on the second upright bars and hinged to the first upright bars; first rotating rings and second rotating rings mounted on the vertical bars; a first diagonal bar mounted on one of the first rotating rings and a second diagonal bar mounted on one of the second rotating rings.

### BACKGROUND OF THE INVENTION

### 1. Technical Field

The application relates to the technical field of carts, in particular to a portable and frameless folding cart capable of being folded without increasing the height.

### 2. Description of Related Art

Carts are transport vehicles pushed and pulled manually and the origination of all vehicles. Although the material handling technique of the carts is developing continuously, the carts are still used as indispensable transport facilities and are widely used in production and life because they are low in production cost, easy to maintain and operate, low in weight, capable of working in places where motor vehicles cannot be used, and suitable for transporting light articles in a short distance.

For example, Patent Publication No.CN115583274 A specifically discloses a center-folding cart. Multiple sides of the cart in this patent may be folded to the center by means of Y-shaped folding assemblies of front and back walls, foldable side walls and a foldable bottom frame, and the size of the cart in the folded state is greatly reduced and smaller, such that the cart may be easily stored in a storage box.

In the implementation process of the above patent, although the cart may be folded to occupy less space, the overall height of the cart in the folded state is greater than that of the cart in the unfolded state, so the cart in the folded state occupies much space in the height direction. To solve this problem, it is necessary to provide a portable and frameless folding cart capable of being folded without increasing the height.

It should be noted that the above information disclosed in the description of related art is merely for a comprehension of the background art of the concept of the application, so information that does not belong to the prior art may be included.

### BRIEF SUMMARY OF THE INVENTION

In view of the above problem in the prior art, the technical issue to be settled by the application is to provide a portable and frameless folding cart capable of being folded without increasing the height to solve the problem that the height of an existing cart is increased after the cart is folded.

The technical solution adopted by the invention to settle the above-mentioned problems is as follows: a portable and frameless folding cart capable of being folded without increasing the height includes: four vertical bars used for supporting and divided into two front vertical bars and two rear vertical bars; bottom sleeves mounted at bottom ends of the vertical bars; a first cross bar and a second cross bar which are mounted between the bottom sleeves; first retaining rings mounted at the bottom ends of the front vertical bars and second retaining rings mounted at the bottom ends of the rear vertical bars; first upright bars rotatably arranged on the first retaining rings and second upright bars rotatably arranged on the second retaining rings; hinge sleeves mounted on the second upright bars and hinged to the first upright bars; first rotating rings mounted on the front vertical bars and second rotating rings mounted on the rear vertical bars; a first diagonal bar mounted on one of the first rotating rings and a second diagonal bar mounted on one of the second rotating rings; a wheel mechanism used for driving the cart to move; a pulling mechanism to be held by a worker; and a folding assembly used for supporting a bottom of the cart when the cart is in an unfolded state, wherein the folding assembly includes stationary shafts fixedly mounted on the first diagonal bar and the second diagonal bar, upper sleeves are rotatably mounted at upper ends of the stationary shafts, an upper bar is mounted between the two upper sleeves, two clamping sleeves are arranged on the upper bar, and first openings are formed in upper ends of the clamping sleeves; lower sleeves are rotatably mounted at lower ends of the stationary shafts, a lower bar is mounted between the two lower sleeves, and an intermediate shaft is rotatably mounted between a middle of the lower bar and a middle of the upper bar.

A portable and frameless folding cart capable of being folded without increasing the height includes: four vertical bars used for supporting and divided into two front vertical bars and two rear vertical bars; bottom sleeves mounted at bottom ends of the vertical bars; a first cross bar and a second cross bar which are mounted between the bottom sleeves; first retaining rings mounted at the bottom ends of the front vertical bars and second retaining rings mounted at the bottom ends of the rear vertical bars; first upright bars rotatably arranged on the first retaining rings and second upright bars rotatably arranged on the second retaining rings; hinge sleeves mounted on the second upright bars and hinged to the first upright bars; first rotating rings mounted on the front vertical bars and second rotating rings mounted on the rear vertical bars; a first diagonal bar mounted on one of the first rotating rings and a second diagonal bar mounted on one of the second rotating rings; a wheel mechanism used for driving the cart to move; a pulling mechanism to be held by a worker; and a folding assembly used for supporting a bottom of the cart when the cart is in an unfolded state, wherein the folding assembly includes lower ring sleeves fixedly mounted on the first diagonal bar and the second diagonal bar, upper rotating shafts are rotatably arranged on the lower ring sleeves, a link is mounted between the two upper rotating shafts, two transition sleeves are arranged on the link, and second openings are formed in upper ends of the transition sleeves.

A portable and frameless folding cart capable of being folded without increasing the height includes: four vertical bars used for supporting and divided into two front vertical bars and two rear vertical bars; bottom sleeves mounted at bottom ends of the vertical bars; a first cross bar and a second cross bar which are mounted between the bottom sleeves; first retaining rings mounted at the bottom ends of the front vertical bars and second retaining rings mounted at the bottom ends of the rear vertical bars; first upright bars rotatably arranged on the first retaining rings and second upright bars rotatably arranged on the second retaining rings; hinge sleeves mounted on the second upright bars and hinged to the first upright bars; first rotating rings mounted on the front vertical bars and second rotating rings mounted on the rear vertical bars; a first diagonal bar mounted on one of the first rotating rings and a second diagonal bar mounted on one of the second rotating rings; a wheel mechanism used for driving the cart to move; a pulling mechanism to be held by a worker; and a folding assembly used for supporting a bottom of the cart when the cart is in an unfolded state, wherein an extension mechanism is arranged at an upper end of each vertical bar and includes an extension block disposed around the upper end of the vertical bar, an oval groove is formed in the vertical bar and penetrates through the vertical bar, a transition bar is slidably arranged in the oval groove, and an extension bar is mounted in the transition bar; a spring is mounted between the transition bar and a bottom of the oval groove, and a limit step is arranged at a bottom end of an inside of the extension block and divides the inside of the extension block into a first section located below and a second section located above, wherein a size of the first section matches a size of the transition bar, and a size of the second section is less than the size of the transition bar; and a bump is arranged at a bottom of the transition bar, and a slideway matched with the bump is arranged on the first section of the extension block.

Further, a horizontal through-groove is formed in an upper end of the extension block, a limit block is slidably arranged in the through-groove, the limit block extends out of an outer end of the vertical bar to form a button, an elastic portion is mounted between the limit block and the vertical bar, and a limit groove is formed in the limit block; and a square block is arranged at an upper end of the extension bar.

Further, the wheel mechanism includes wheel carriers detachably mounted at lower ends of the front vertical bars, front wheels are rotatably mounted on the wheel carriers, connecting bases are detachably mounted at lower ends of the rear vertical bars, and rear wheels are rotatably mounted on the connecting bases; and a connecting shaft is rotatably connected between the two connecting bases, and a foot brake is arranged on the connecting shaft.

Further, a pulling mechanism is arranged on the first cross bar, the pulling mechanism includes a stationary base mounted on the first cross bar, and a bottom pulling bar is rotatably arranged on the stationary base; a sliding cavity is formed in the bottom pulling bar, a top pulling bar is slidably mounted in the sliding cavity, and a grip is mounted at a top end of the top pulling bar; and a bushing is disposed around the bottom pulling bar, and a locking portion is arranged on the bushing.

Further, protective sleeves are arranged at the lower ends of the vertical bars, second arc-shaped grooves are formed in upper ends of the protective sleeves, and horizontal first arc-shaped grooves are formed in lower ends of the protective sleeves.

Further, a connecting pin is arranged at a top end of the extension bar, a canopy mechanism is arranged at a top of the connecting pin, the canopy mechanism includes a top sleeve detachably disposed around the connecting pin, a rotating sleeve is rotatably arranged on the top sleeve, and a top bar is inserted into the rotating sleeve.

Further, an insertion block is connected to positions, away from the rotating sleeves, of the four top bars, insertion sleeves are rotatably connected to the insertion block, and the insertion sleeves are connected to positions, away from the rotating sleeves, of the top bars.

Further, a handle mechanism is mounted at top ends of the rear vertical bars, the handle mechanism includes female rings mounted on the corresponding extension blocks, a plurality of clamping grooves are formed in each female ring in a circumferential direction, and a male ring is arranged on a side of each female ring;

insertion bars are arranged on the male rings, and insertion holes matched with the insertion bars are formed in the female rings;

extension sleeves are arranged on the male rings, bent bars are inserted into the extension sleeves, and a handle is disposed around the two bent bars.

The portable and frameless folding cart capable of being folded without increasing the height provided by the application has the following beneficial effects:

1. By means of the folding assembly, the cart may be in an unfolded state and a folded state and has a small size in the folded state, thus being easy to store; in addition, the overall height of the cart is not increased in the folding process of the cart, thus further reducing the difficulty in storage of the cart.

2. By means of the extension mechanisms, the top end of the cart may be extended, and the canopy mechanisms are arranged to protect the cart.

3. By means of the handle mechanism, workers may hold the cart by hand, and the cart may be operated by multiple workers when used for transporting heavy goods, thus reducing the difficulty in transportation of the goods.

In addition to the purposes, features and advantages described above, the application has other purposes, features and advantages. The application is described in further detail below with reference to accompanying drawings.

### BRIEF DESCRIPTION OF THE SEVERAL VIEWS OF THE DRAWINGS

Drawings, constituting one part of the application, are used to provide a further understanding of the application. Illustrative embodiments of the application and the description thereof are used to explain the application and should not be construed as improper limitations of the application.

In the drawings:

FIG. 1 is a first overall schematic diagram of a portable and frameless folding cart capable of being folded without increasing the height according to the application.

FIG. 2 is a second overall schematic diagram of a portable and frameless folding cart capable of being folded without increasing the height according to the application.

FIG. 3 is a schematic exploded view of the overall structure in FIG. 2.

FIG. 4 is a schematic structural diagram of part A in FIG. 1.

FIG. 5 is a schematic structural diagram of part B in FIG. 2.

FIG. 6 is a schematic structural diagram of part C in FIG. 3.

FIG. 7 is a schematic structural diagram of part D in FIG. 3.

FIG. 8 is a schematic structural diagram of part E in FIG. 3.

FIG. 9 is a schematic structural diagram of part F in FIG. 3.

FIG. 10 is a schematic structural diagram of part G in FIG. 3.

### REFERENCE SIGNS

1, cart frame; 11, vertical bar; 12, first upright bar; 13, second upright bar; 14, hinge sleeve; 15, first cross bar; 16, edge cross bar; 17, intermediate upright bar; 18, intermediate cross bar; 19, protective sleeve; 191, first arc-shaped groove; 192, second arc-shaped groove; 110, first diagonal bar; 111, second diagonal bar; 112, upper sleeve; 113, lower sleeve; 114, upper bar; 115, lower bar; 116, intermediate shaft; 117, clamping sleeve; 118, lower ring sleeve; 119, upper rotating shaft; 120, link; 121, transition sleeve; 123, bottom sleeve; 124, retaining ring; 125, rotating ring; 126, second cross bar;

2, extension mechanism; 21, extension bar; 211, square block; 212, connecting pin; 22, extension block; 221, through-groove; 23, female ring; 231, clamping groove; 24, limit block; 241, button; 242, limit groove; 25, transition bar; 251, notch; 252, bump; 26, spring; 27, cover plate; 28, male ring; 281, clamping teeth; 282, extension sleeve; 283, insertion bar;

3, wheel mechanism; 31, front wheel; 32, rear wheel; 33, wheel carrier; 34, connecting base; 35, foot brake; 36, connecting shaft;

4, pulling mechanism; 41, bottom pulling bar; 42, top pulling bar; 43, grip; 44, bushing; 45, locking portion; 46, stationary base;

5, handle mechanism; 51, bent bar; 52, handle;

6, canopy mechanism; 61, top bar; 62, insertion block; 63, top sleeve; 64, rotating sleeve; 65, insertion sleeve.

### DETAILED DESCRIPTION OF THE INVENTION

It should be noted that the embodiments of the application and features in the embodiments may be combined without conflicts. The application is described in detail below with reference to the drawings and embodiments.

To allow those skilled in the art to have a better understanding of the technical solutions of the application, the technical solutions in the embodiments of the application are clearly and completely described below in conjunction with accompanying drawings of the embodiments of the application. Apparently, the embodiments described here are merely illustrative ones and are not all possible ones of the application. All other embodiments obtained by those ordinarily skilled in the art according to the following one without creative labor should also fall within the protection scope of the application.

### Embodiment 1

The structure and folding principle of a cart are expounded in this embodiment. Specifically:

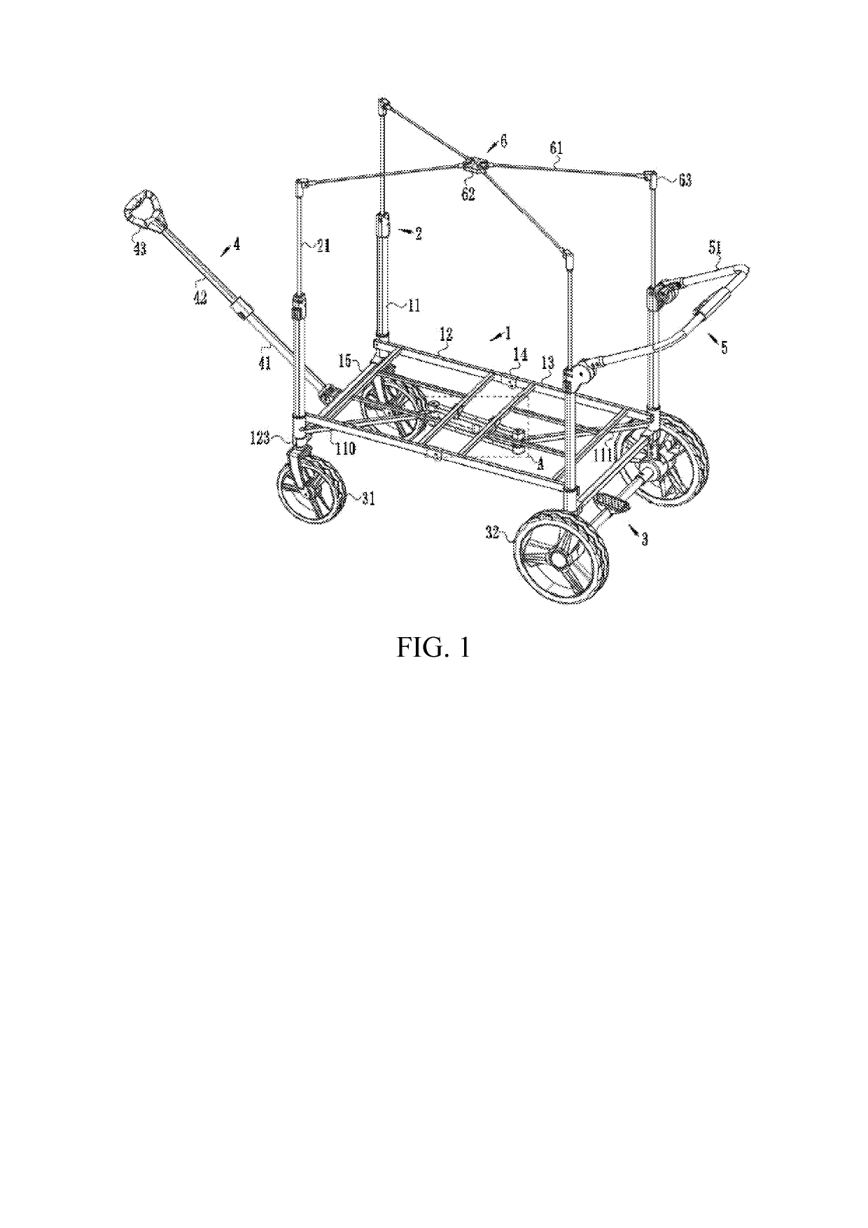

As shown in FIG. 1, the application provides a portable and frameless folding cart capable of being folded without increasing the height, including a cart frame 1. The cart frame 1 is a main body of the cart and used for carrying goods. The cart frame 1 includes four vertical bars 11. For the convenience of description, with the view in FIG. 1 as an example, the two vertical bars 11 on the left are defined as front vertical bars and the two vertical bars 11 on the right are defined as rear vertical bars, in the heading direction of the cart.

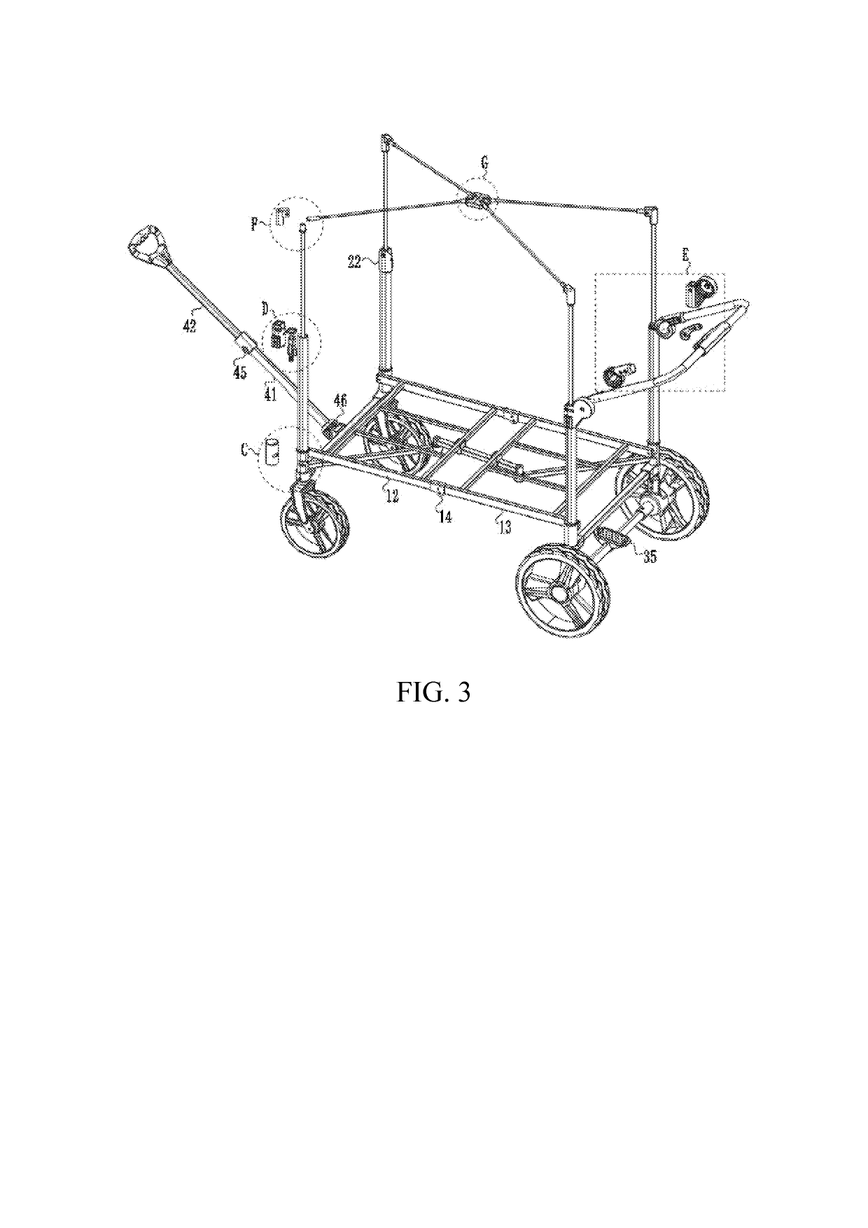

As shown in FIGS. 1-3 and 6, bottom sleeves 123 are fixedly mounted at bottom ends of the four vertical bars 11. A first cross bar 15 is fixedly mounted between the two bottom sleeves 123 located on the front vertical bars, and a second cross bar 126 is fixedly mounted between the two bottom sleeves 123 located on the rear vertical bars, such that the two front vertical bars are connected by means of the first cross bar 15 and the two rear vertical bars are connected by means of the second cross bar 126 to from a stable integral structure.

Meanwhile, retaining rings 124 are fixedly arranged at the bottom ends of the two front vertical bars and the bottom ends of the two rear vertical bars. For the convenience of description, the retaining rings 124 connected to the front vertical bars are defined as first retaining rings, and the retaining rings 124 connected to the rear vertical bars are defined as second retaining rings.

In addition, first upright bars 12 are rotatably arranged on the first retaining rings, such that the first upright bars 12 are rotatable around the first retaining rings in a vertical direction. Second upright bars 13 are rotatably arranged on the second retaining rings, such that the second upright bars 13 are rotatable around the second retaining rings in the vertical direction.

Further referring to FIGS. 1-3 and 6, hinge sleeves 14 are mounted at positions, away from the second retaining rings, of the second upright bars 13, and the hinge sleeves 14 are hinged to ends, away from the first retaining rings, of the first upright bars 12, such that the vertical upright bars 12 and the second upright bars 13 may be rotated relatively to be in a horizontal state to make the cart in an unfolded state and to be in a vertical state to make the cart in a folded state.

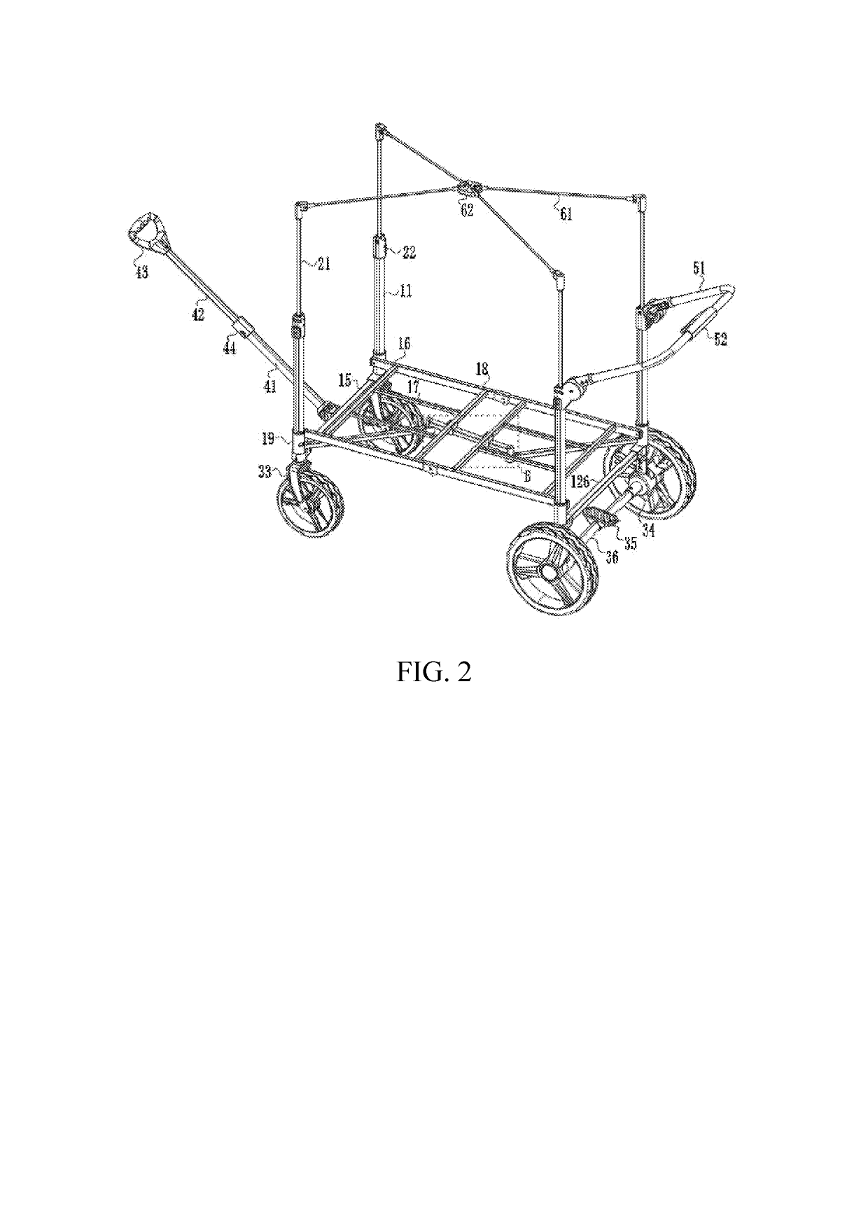

As shown in FIGS. 1-2, an edge cross bar 16 and an intermediate cross bar 18 are fixedly mounted between the two first upright bars 13, an edge cross bar 16 and an intermediate cross bar 18 are fixedly mounted between the two second upright bars 13, the edge cross bars 16 are close to the vertical bars 11, and the intermediate cross bars 18 are close to the hinge sleeves 14, such that the upright bars are kept stable by means of the edge cross bars 16 and the intermediate cross bars 18.

Meanwhile, two intermediate upright bars 17 are fixedly mounted between each edge cross bar 16 and the corresponding intermediate cross bar 18 and arranged symmetrically, such that the stability of the cart is further improved.

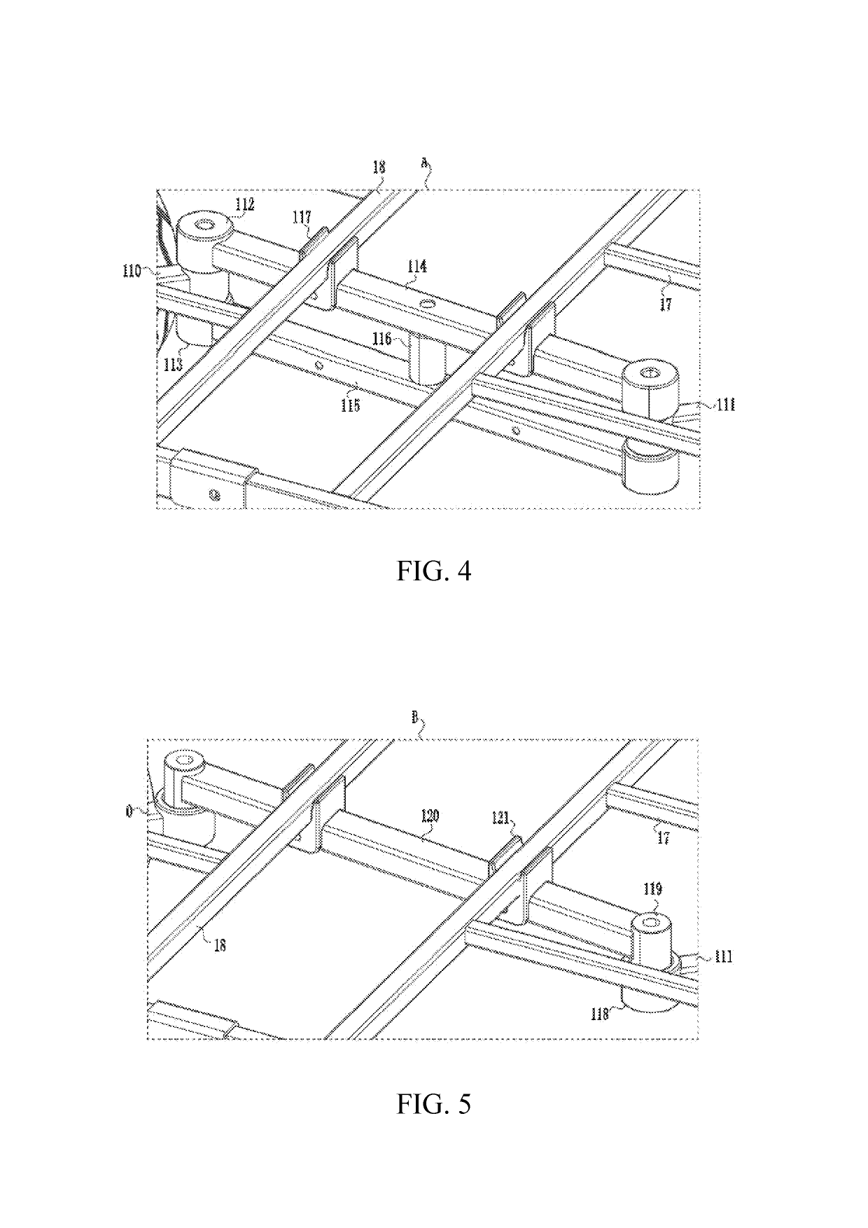

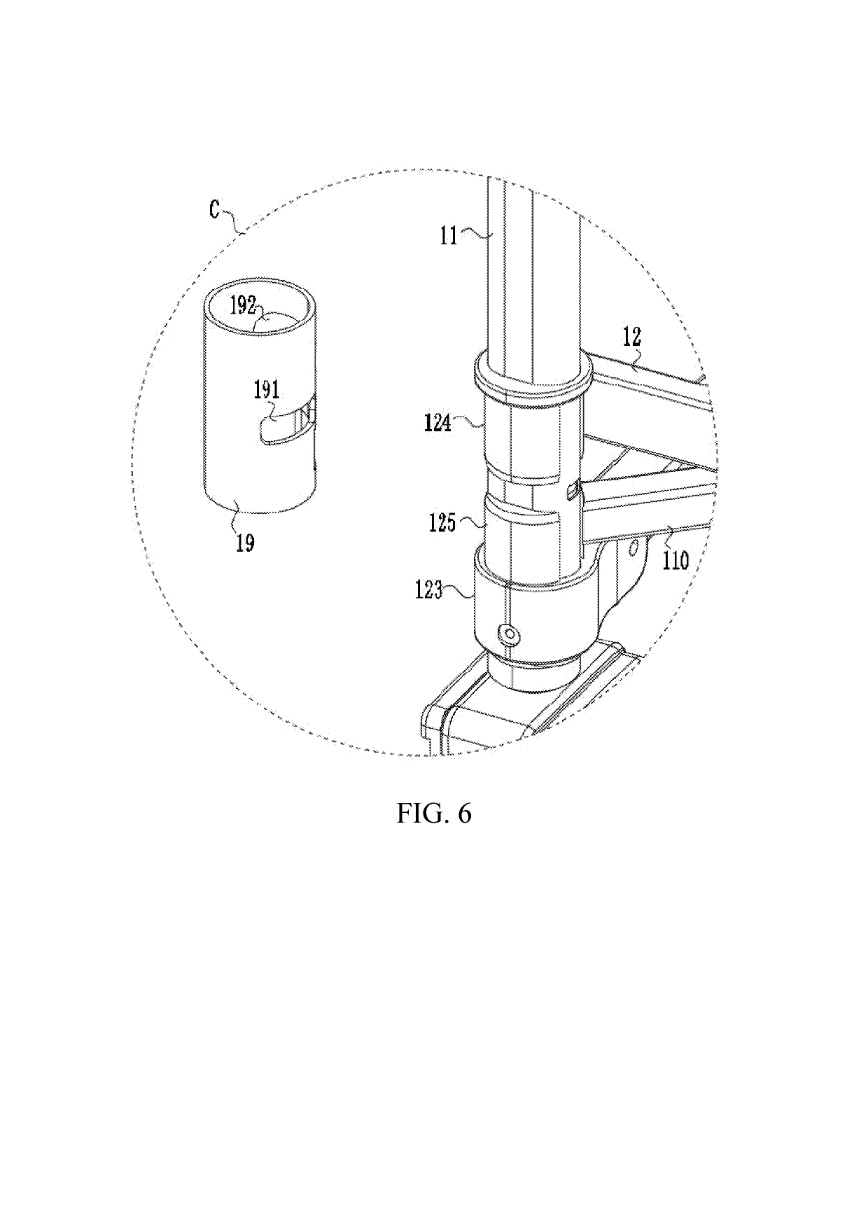

As shown in FIGS. 4 and 6, rotating rings 125 are rotatably arranged on the vertical bars 11 and located between the bottom sleeves 123 and the retaining rings 124. For the convenience of description, the rotating rings 125 mounted on the front vertical bars are defined as first rotating rings, and the rotating rings 125 mounted on the rear vertical bars are defined as second rotating rings. One set of first rotating rings and one set of second rotating rings are arranged and located on the front vertical bars and the rear vertical bars which are arranged diagonally.

Meanwhile, a first diagonal bar 110 is fixedly mounted on one of the first rotating rings, and one end of the first diagonal bar 110 is configured to rotate around the corresponding front vertical bar in the horizontal direction as the first rotating rings rotate. A second diagonal bar 111 is fixedly mounted on one of the second rotating rings, and one end of the second diagonal bar 111 is configured to rotate around the corresponding rear vertical bar in the horizontal direction as the second rotating rings rotate.

In this embodiment, the other end of the first diagonal bar 110 and the other end of the second diagonal bar 111 are connected to a folding assembly. The folding assembly is configured to be folded with the cart and support the bottom of the cart when the cart is in the unfolded state.

As shown in FIG. 4, the folding assembly includes stationary shafts (not shown) fixedly mounted on the first diagonal bar 110 and the second diagonal bar 111.

Upper sleeves 112 are rotatably mounted at upper ends of the stationary shafts, an upper bar 114 is fixedly mounted between the two upper sleeves 112, and two clamping sleeves 117 are fixedly arranged on the upper bar 114. First openings (not shown) are formed in upper ends of the clamping sleeves 117, and the first openings are configured to be clamped with the intermediate cross bars 18 to secure the folding assembly.

Meanwhile, lower sleeves 113 are rotatably mounted at lower ends of the stationary shafts, a lower bar 115 is fixedly mounted between the two lower sleeves 113, and an intermediate shaft 116 is rotatably mounted between the middle of the lower bar 115 and the middle of the upper bar 114, such that the lower bar 115 and the upper bar 114 are connected by means of the intermediate shaft 116.

To sum up, when the cart is used, the first upright bars 12 and the second upright bars 13 are in the horizontal state, the intermediate cross bars 18 are clamped in the first openings of the clamping sleeves 117, and at this moment, the cart is in the unfolded state and allows goods to be loaded therein.

When the cart is not used, a worker pulls the intermediate cross bars 18 upwards until the intermediate cross bars 18 disengage from the clamping sleeves 117, the first upright bars 12 and the second upright bars 13 rotate relatively to be in the vertical state, and at this moment, the cart is switched to the folded state and has a small size, thus being easy to store. In addition, in the folding process of the cart, the overall height of the cart is not increased, thus further reducing the difficulty in storage of the cart.

As another embodiment of the folding assembly, as shown in FIG. 5, the folding assembly includes lower ring sleeves 118 which are fixedly mounted on the first diagonal bar 110 and the second diagonal bar 111, upper rotating shafts 119 are rotatably arranged on the lower ring sleeves 118, a link 120 is fixedly mounted between the two upper rotating shafts 119, two transition sleeves 121 are fixedly arranged on the link 120, second openings (not shown) are formed in upper ends of the transition sleeves 121, and the second openings are configured to be clamped with the intermediate cross bars 18 to secure the folding assembly.

As shown in FIG. 6, protective sleeves 19 are fixedly arranged at lower ends of the vertical bars 11, the protective sleeves 19 are located outside the retaining rings 124 and the rotating rings 125 and used for protecting the retaining rings 124 and the rotating rings 125, second arc-shaped grooves 192 are formed in upper ends of the protective sleeves 19, the second arc-shaped grooves 192 are configured to provide space for the connection between the first upright bars 12 and the retaining rings 124, and horizontal first arc-shaped grooves 191 are formed in lower ends of the protective sleeves 19, and the first arc-shaped grooves 191 are configured to give way to the first diagonal bar 110 (the second diagonal 111) when the first diagonal bar 110 (the second diagonal 111) rotates.

To facilitate the movement of the cart, as shown in FIGS. 1-3, a wheel mechanism 3 is mounted at the bottoms of the vertical bars 11. The wheel mechanism 3 is used for driving the cart to move or locking the cart. The wheel mechanism 3 includes wheel carriers 33 detachably mounted at the lower ends of the front vertical bars, front wheels 31 are rotatably mounted on the wheel carriers 33, connecting bases 34 are detachably mounted at the lower ends of the rear vertical bars, rear wheels 32 are rotatably mounted on the connecting bases 34, and the front wheels 31 and the rear wheels 32 work together to drive the cart to move.

To realize braking of the cart, a connecting shaft 36 is rotatably connected between the two connecting bases 34, a foot brake 35 is arranged on the connecting shaft 36, and a worker may step on the foot brake 35 to realize braking of the rear wheels 32.

It should be noted that the structure and principle for realizing braking of the rear wheels 32 by means of the foot brake 35 may be understood with reference to Patent Publication No.CN214451255 U and will not be detailed here.

To ensure that the cart may be easily operated by a worker, as shown in FIGS. 1-3, a pulling mechanism 5 is arranged on the first cross bar 15. The worker holds the pulling mechanism 4 to pull the cart to move. The pulling mechanism 4 includes a stationary base 46 fixedly mounted on the first cross bar 15. A bottom pulling bar 41 is rotatably arranged on the stationary base 46, such that the bottom pulling bar 41 is able to rotate around the first cross bar 15 to adjust the pulling angle of the cart.

Meanwhile, a sliding cavity (not shown) is formed in a position, away from the first cross bar 15, of the bottom pulling bar 41, a top pulling bar 42 is slidably mounted in the sliding cavity, and the top pulling bar 42 is configured to slide in the sliding cavity, such that the top pulling bar 42 slides out of the sliding cavity when the cart is unfolded and is stored in the sliding cavity when the cart is folded, thus reducing the space occupied by the top pulling bar 42. A grip 43 is fixedly mounted at a top end of the top pulling bar 42, and a worker may hold the grip 43 by hand to operate the cart.

In addition, a bushing 44 is fixedly disposed around the bottom pulling bar 41 and located at an opening of the sliding cavity, a locking portion 45 is arranged on the bushing 44, and the locking portion 45 penetrates through the bushing 44 and the bottom pulling bar 41 and extends into the sliding cavity to abut against the top pulling bar 42, or the locking portion 45 retracts to be away from the top pulling bar 42 to allow the top pulling bar 42 to slide in the sliding cavity, such that sliding and locking of the top pulling bar 42 in the bottom pulling bar 41 are realized.

### Embodiment 2:

In use of the cart, the cart often needs to be applied to some special occasions, for example, the cart may be used as a temporary vending point. In this case, a canopy needs to be additionally arranged to shield against the sun or rainwater, and workers often have to add bars to fix the canopy, increasing the difficulty of field operation.

To solve the above problem, as shown in FIGS. 1-3, an extension mechanism 2 is arranged at an upper end of each vertical bar 11 and used for extending the vertical bar 11, such that a proper accessory may be added to the upper end of the vertical bar 11.

As shown in FIGS. 1-3 and 7, the extension mechanism 2 includes an extension block 22 fixedly disposed around the upper end of the vertical bar 11, an oval groove (not shown) is formed in the vertical bar 11 and penetrates through the vertical bar 11, and a transition bar 25 is slidably arranged in the oval groove, such that the transition bar 25 is slidable in the oval groove in the vertical direction. It should be noted that an extension bar 21 is fixedly mounted in the transition bar 25, such that the extension bar 21 moves synchronously with the transition bar 25.

Meanwhile, a spring 26 is fixedly mounted between the transition bar 25 and the bottom of the oval groove, such that the transition bar 25 is located at the upper end of the vertical bar 11 in an initial state, under the action of the spring 26.

In addition, a limit step (not shown) is arranged at a bottom end of the inside of the extension block 22 and divides the inside of the extension block 22 into a first section located below and a second section located above. The size of the first section matches the size of the transition bar 25, and the size of the second section is less than the size of the transition bar 25, such that the transition bar 25 is prevented by the limit step from disengaging from the vertical bar 11.

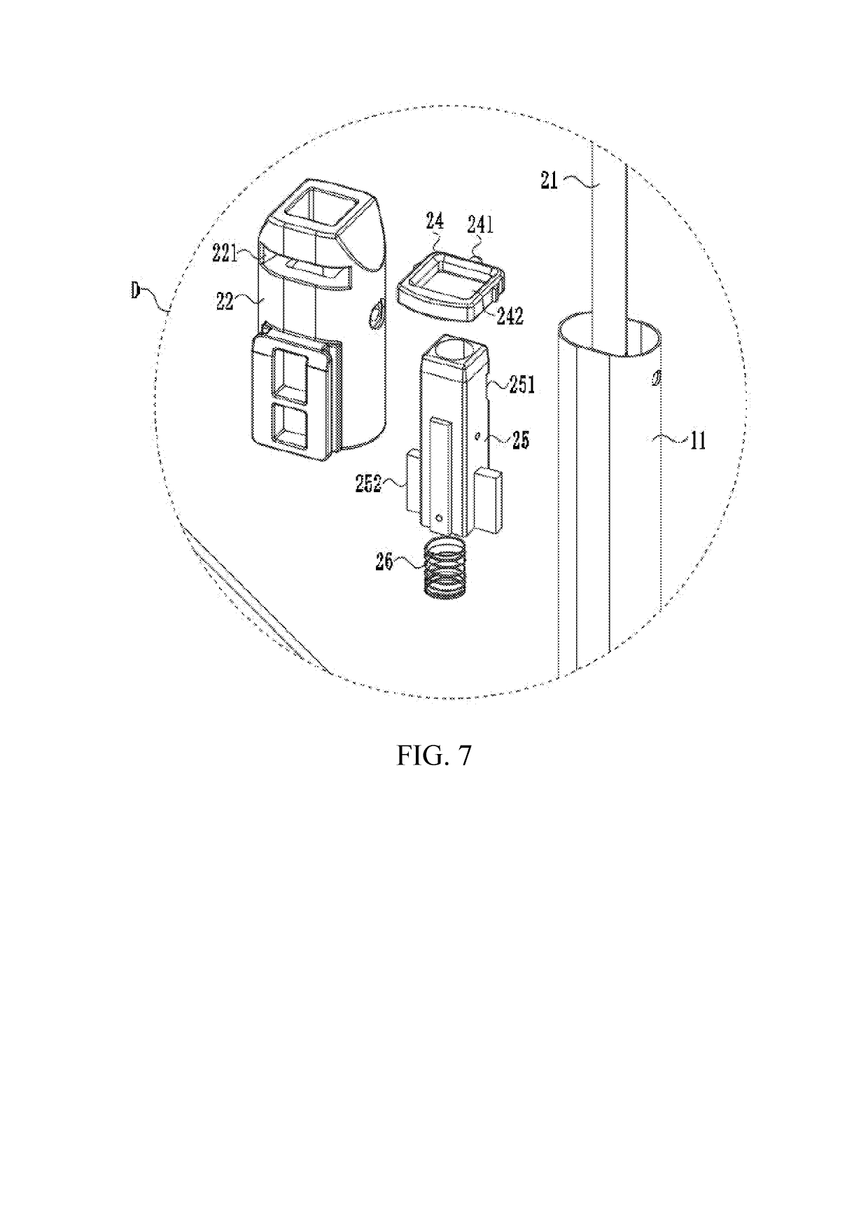

Further referring to FIG. 7, a bump 252 is arranged at the bottom of the transition bar 25, and a slideway (not shown) matched with the bump 252 is arranged on the first section of the extension block 22, such that the transition bar 25 may slide to the upper end of the vertical bar 11 more stably by cooperation between the slideway and the bump 252.

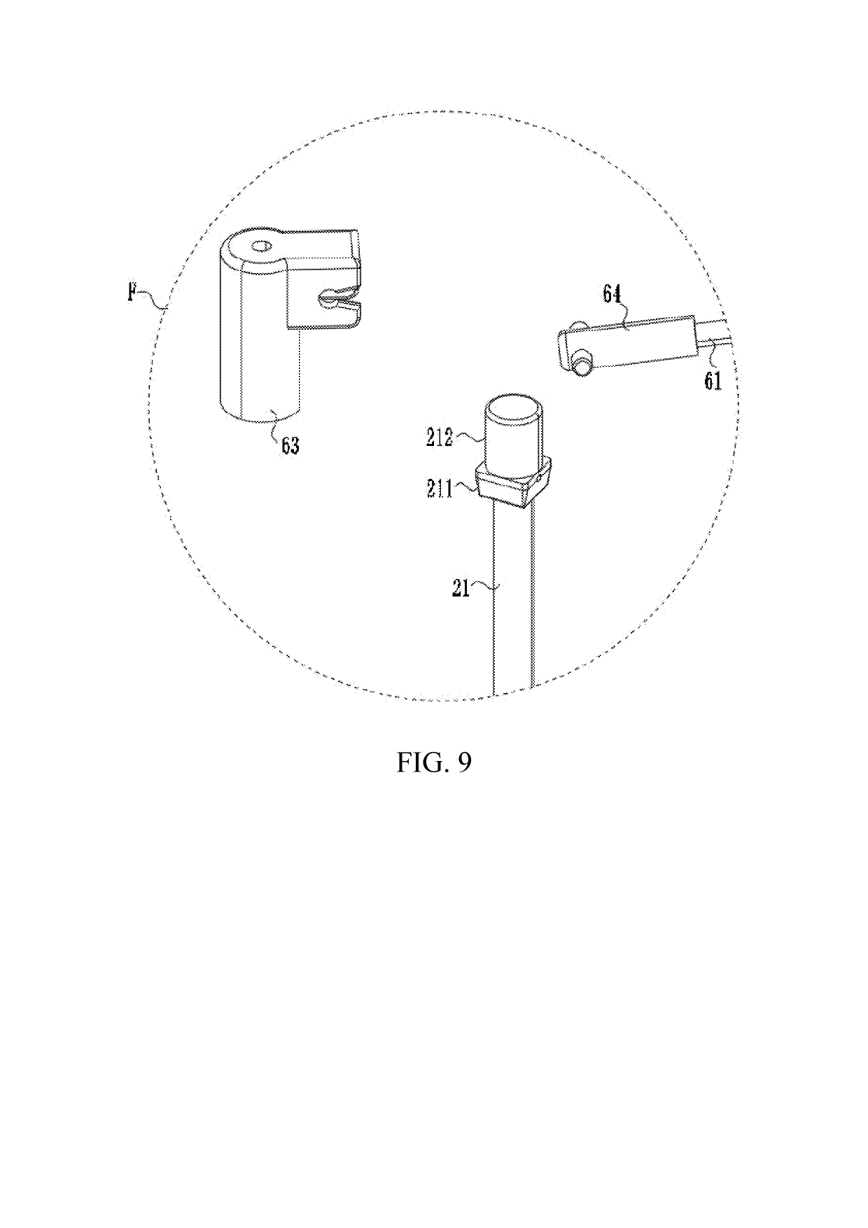

To fix the position of the extension bar 21, as shown in FIGS. 7 and 9, a horizontal through-groove 221 is formed in an upper end of the extension block 22, a limit block 24 is slidably arranged in the through-groove 221, the limit block 24 extends out of an outer end of the vertical bar 11 and forms a button 241, and an elastic portion (not shown) is mounted between the limit block 24 and the vertical bar 11. It should be noted that a limit groove 242 is formed in the limit block 24, the limit groove 242 is aligned with the axis of the transition bar 25 when the elastic element is pressed, and a notch 251 is formed in an upper end of the transition bar 25, such that when the elastic portion is in the initial state, the limit block 24 is clamped in the notch 251 to limit the transition bar 25.

Meanwhile, a square block 211 is arranged at an upper end of the extension bar 21. In the initial state, the elastic portion may be located at an upper end of the square block 211 to limit the extension bar 21.

It may be understood that in the initial state, the extension bar 21 is stored in the vertical bar 11, and at this moment, the limit block 24 is located at the upper end of the square block 211 to limit the position of the extension bar 21.

When the extension bar 21 needs to be pulled out, the button 241 is pressed to allow the limit groove 242 to be aligned with the transition bar 25, at this moment, the extension bar 21 is released by the limit block 24, the transition bar 25 is driven by the spring 26 to move upwards, and the extension bar 21 is driven to move upwards synchronously to the highest position.

At this moment, the button 241 is released, and the limit block 24 returns to be clamped in the notch 251, such that the extension bar 21 in the extended state is limited to guarantee the stability of the extension bar 21.

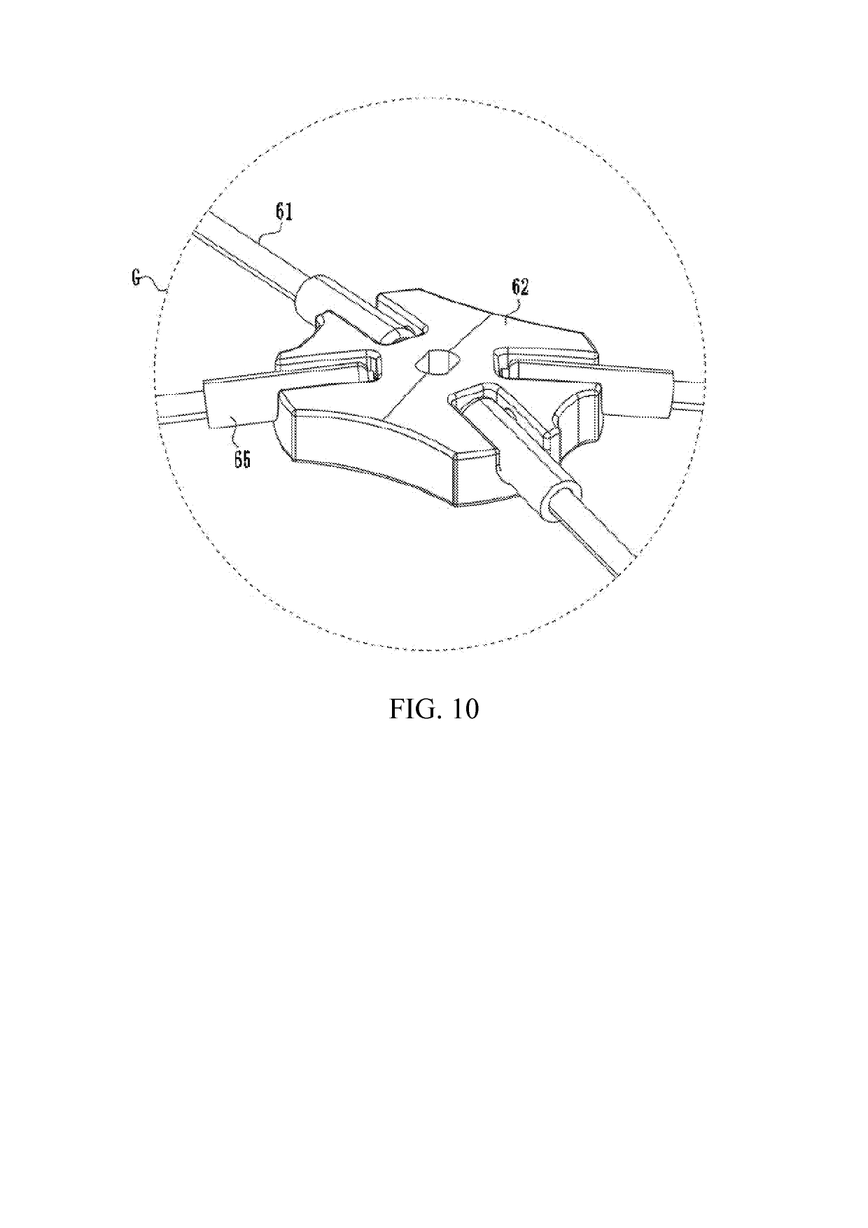

As shown in FIGS. 1 and 9-10, a connecting pin 212 is arranged at a top end of the extension bar 21, a canopy mechanism 6 is arranged at a top of the connecting pin 212, the canopy mechanism 6 is configured to arrange a canopy at the top end of the cart and includes a top sleeve 63 detachably disposed around the connecting pin 212, a rotating sleeve 64 is rotatably arranged on the top sleeve 63, and a top bar 61 is inserted into the rotating sleeve 64.

Meanwhile, an insertion block 62 is connected to positions, away from the rotating sleeves 64, of the four top bars 61, insertion sleeves 65 are rotatably connected to the insertion block 62, and the insertion sleeves 65 are disposed around positions, away from the rotating sleeves 64, of the top bars 61, such that the four top bars 61 are stably connected by means of the insertion block 62, and the canopy may be fixed easily to shelter and protect the cart.

As shown in FIGS. 2-3 and 8, a handle mechanism 5 is mounted at top ends of the rear vertical bars. The handle mechanism 5 includes female rings 23 fixedly mounted on the extension blocks 22 located on the rear vertical bars, a plurality of clamping grooves 231 are formed in each female ring 23 in a circumferential direction, a male ring 28 is arranged on one side of each female ring 23, clamping teeth 281 matched with the clamping grooves 231 are arranged on the male ring 28 in the circumferential direction, and the clamping teeth 281 work together with the clamping grooves 231 to realize snap fit between the male rings 28 and the female rings 23.

Insertion bars 283 are fixedly arranged on the male rings 28, insertion holes (not shown) matched with the insertion bars 283 are formed in the female rings 23, and the insertion bars 283 may extend into the insertion holes to fulfill a guide effect when the male rings 28 and the female rings 23 are connected.

A cover plate 27 is mounted on one side of each male ring 28 to seal the side of the male ring 28.

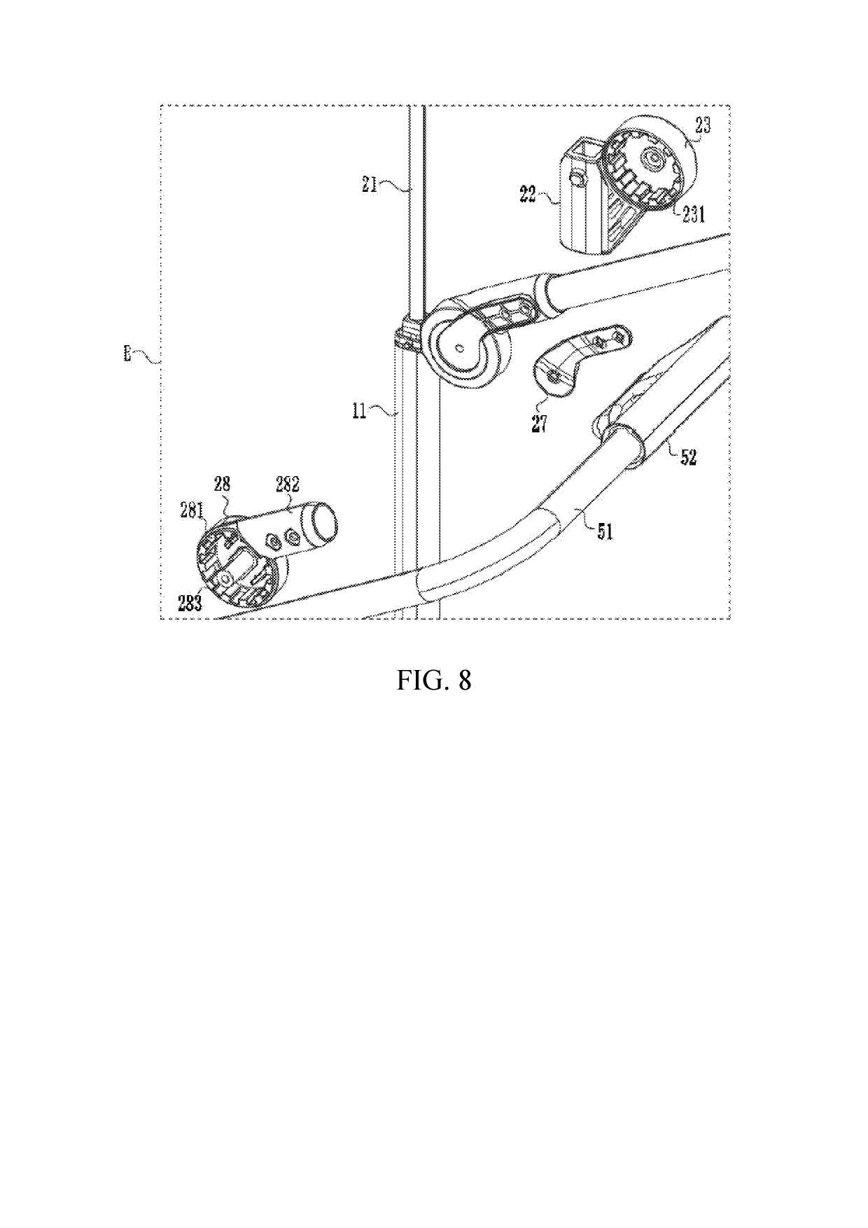

Further referring to FIG. 8, extension sleeves 282 are arranged on the male rings 28, and bent bars 51 are arranged in the extension sleeves 282, and a handle 52 is disposed around the two bent bars 51. The two bent bars 51 are connected by means of the handle 52, such that a worker may hold the handle 52 by hand to push the cart.

It should be noted that elastic elements are arranged between the bent bars 51 and the handle 52, such that the bent bars 51 are slidable in the handle 52. When the angle of the bent bars 51 needs to be adjusted, the two bent bars 51 are moved close to each other to separate the male rings 28 from the female rings 23, then the male rings 28 rotate with respect to the female rings 23, and then the angle of the bent bars 51 may be adjusted by cooperation between the clamping teeth 281 at different positions and the clamping grooves 231 to satisfy the operation requirements of different workers.

The above embodiments are merely preferred ones of the application and are not intended to limit the application. For those skilled in the art, various modifications and transformations may be made to the application. Any modifications, equivalent substitutions and improvements made based on the spirit and principle of the application should fall within the protection scope of the application.

What is claimed is:

1. A portable and frameless folding cart capable of being folded without increasing the height, comprising:
four vertical bars (11) used for supporting and divided into two front vertical bars and two rear vertical bars;
bottom sleeves (123) mounted at bottom ends of the vertical bars (11);
a first cross bar (15) and a second cross bar (126) which are mounted between the bottom sleeves (123);
first retaining rings mounted at the bottom ends of the front vertical bars and second retaining rings mounted at the bottom ends of the rear vertical bars;
first upright bars (12) rotatably arranged on the first retaining rings and second upright bars (13) rotatably arranged on the second retaining rings;
hinge sleeves (14) mounted on the second upright bars (13) and hinged to the first upright bars (12);
first rotating rings mounted on the front vertical bars and second rotating rings mounted on the rear vertical bars;
a first diagonal bar (110) mounted on one of the first rotating rings and a second diagonal bar (111) mounted on one of the second rotating rings;
a wheel mechanism (3) used for driving the cart to move;
a pulling mechanism (4) to be held by a worker; and
a folding assembly used for supporting a bottom of the cart when the cart is in an unfolded state, wherein the folding assembly comprises:
stationary shafts fixedly mounted on the first diagonal bar (110) and the second diagonal bar (111), wherein upper sleeves (112) are rotatably mounted at upper ends of the stationary shafts, an upper bar (114) is mounted between the two upper sleeves (112), two clamping sleeves (117) are arranged on the upper bar (114), and first openings are formed in upper ends of the clamping sleeves (117);
lower sleeves (113) are rotatably mounted at lower ends of the stationary shafts, a lower bar (115) is mounted between the two lower sleeves (113), and an intermediate shaft (116) is rotatably mounted between a middle of the lower bar (115) and a middle of the upper bar (114).

2. A portable and frameless folding cart capable of being folded without increasing the height, comprising:
four vertical bars (11) used for supporting and divided into two front vertical bars and two rear vertical bars;
bottom sleeves (123) mounted at bottom ends of the vertical bars (11);
a first cross bar (15) and a second cross bar (126) which are mounted between the bottom sleeves (123);
first retaining rings mounted at the bottom ends of the front vertical bars and second retaining rings mounted at the bottom ends of the rear vertical bars;
first upright bars (12) rotatably arranged on the first retaining rings and second upright bars (13) rotatably arranged on the second retaining rings;
hinge sleeves (14) mounted on the second upright bars (13) and hinged to the first upright bars (12);
first rotating rings mounted on the front vertical bars and second rotating rings mounted on the rear vertical bars;
a first diagonal bar (110) mounted on one of the first rotating rings and a second diagonal bar (111) mounted on one of the second rotating rings;
a wheel mechanism (3) used for driving the cart to move;
a pulling mechanism (4) to be held by a worker; and
a folding assembly used for supporting a bottom of the cart when the cart is in an unfolded state, wherein the folding assembly comprises:
lower ring sleeves (118) fixedly mounted on the first diagonal bar (110) and the second diagonal bar (111), wherein upper rotating shafts (119) are rotatably arranged on the lower ring sleeves (118), a link (120) is mounted between the two upper rotating shafts (119), two transition sleeves (121) are arranged on the link (120), and second openings are formed in upper ends of the transition sleeves (121).

3. A portable and frameless folding cart capable of being folded without increasing the height, comprising:
four vertical bars (11) used for supporting and divided into two front vertical bars and two rear vertical bars;
bottom sleeves (123) mounted at bottom ends of the vertical bars (11);
a first cross bar (15) and a second cross bar (126) which are mounted between the bottom sleeves (123);
first retaining rings mounted at the bottom ends of the front vertical bars and second retaining rings mounted at the bottom ends of the rear vertical bars;
first upright bars (12) rotatably arranged on the first retaining rings and second upright bars (13) rotatably arranged on the second retaining rings;
hinge sleeves (14) mounted on the second upright bars (13) and hinged to the first upright bars (12);
first rotating rings mounted on the front vertical bars and second rotating rings mounted on the rear vertical bars;
a first diagonal bar (110) mounted on one of the first rotating rings and a second diagonal bar (111) mounted on one of the second rotating rings;
a wheel mechanism (3) used for driving the cart to move;
a pulling mechanism (4) to be held by a worker; and
a folding assembly used for supporting a bottom of the cart when the cart is in an unfolded state;
wherein, an extension mechanism (2) is arranged at an upper end of each said vertical bar (11) and comprises an extension block (22) disposed around the upper end of the vertical bar (11), an oval groove is formed in the vertical bar (11) and penetrates through the vertical bar (11), a transition bar (25) is slidably arranged in the oval groove, and an extension bar (21) is mounted in the transition bar (25);
a spring (26) is mounted between the transition bar (25) and a bottom of the oval groove, and a limit step is arranged at a bottom end of an inside of the extension block (22) and divides the inside of the extension block (22) into a first section located below and a second section located above, wherein a size of the first section matches a size of the transition bar (25), and a size of the second section is less than the size of the transition bar (25);
a bump (252) is arranged at a bottom of the transition bar (25), and a slideway matched with the bump (252) is arranged on the first section of the extension block (22).

4. The portable and frameless folding cart capable of being folded without increasing the height according to claim 3, wherein a horizontal through-groove (221) is formed in an upper end of the extension block (22), a limit block (24) is slidably arranged in the through-groove (221), the limit block (24) extends out of an outer end of the vertical bar (11) to form a button (241), an elastic portion is mounted between the limit block (24) and the vertical bar (11), and a limit groove (242) is formed in the limit block (24);
a square block (211) is arranged at an upper end of the extension bar (21).

5. The portable and frameless folding cart capable of being folded without increasing the height according to claim 4, wherein the wheel mechanism (3) comprises wheel carriers (33) detachably mounted at lower ends of the front vertical bars, front wheels (31) are rotatably mounted on the wheel carriers (33), connecting bases (34) are detachably mounted at lower ends of the rear vertical bars, and rear wheels (32) are rotatably mounted on the connecting bases (34);
a connecting shaft (36) is rotatably connected between the two connecting bases (34), and a foot brake (35) is arranged on the connecting shaft (36).

6. The portable and frameless folding cart capable of being folded without increasing the height according to claim 5, wherein a pulling mechanism (4) is arranged on the first cross bar (15), the pulling mechanism (4) comprises a stationary base (46) mounted on the first cross bar (15), and a bottom pulling bar (41) is rotatably arranged on the stationary base (46);
a sliding cavity is formed in the bottom pulling bar (41), a top pulling bar (42) is slidably mounted in the sliding cavity, and a grip (43) is mounted at a top end of the top pulling bar (42);
a bushing (44) is disposed around the bottom pulling bar (44), and a locking portion (45) is arranged on the bushing (44).

7. The portable and frameless folding cart capable of being folded without increasing the height according to claim 6, wherein protective sleeves (19) are arranged at the lower ends of the vertical bars (11), second arc-shaped grooves (192) are formed in upper ends of the protective sleeves (19), and horizontal first arc-shaped grooves (191) are formed in lower ends of the protective sleeves (19).

8. The portable and frameless folding cart capable of being folded without increasing the height according to claim 7, wherein a connecting pin (212) is arranged at a top end of the extension bar (2), a canopy mechanism (6) is arranged at a top of the connecting pin (212), the canopy mechanism (6) comprises a top sleeve (63) detachably disposed around the connecting pin (212), a rotating sleeve (64) is rotatably arranged on the top sleeve (63), and a top bar (61) is inserted into the rotating sleeve (64).

9. The portable and frameless folding cart capable of being folded without increasing the height according to claim 8, wherein an insertion block (62) is connected to positions, away from the rotating sleeves (64), of the four top bars (61), insertion sleeves (65) are rotatably connected to the insertion block (62), and the insertion sleeves (65) are connected to positions, away from the rotating sleeves (64), of the top bars (61).

10. The portable and frameless folding cart capable of being folded without increasing the height according to claim 9, wherein a handle mechanism (5) is mounted at top ends of the rear vertical bars, the handle mechanism (5) comprises female rings (23) mounted on the corresponding extension blocks (22), a plurality of clamping grooves (231) are formed in each said female ring (23) in a circumferential direction, and a male ring (28) is arranged on a side of each said female ring (23);
insertion bars (283) are arranged on the male rings (28), and insertion holes matched with the insertion bars (283) are formed in the female rings (23);
extension sleeves (282) are arranged on the male rings (28), bent bars (51) are inserted into the extension sleeves (282), and a handle (52) is disposed around the two bent bars (51).
